(19) United States
(12) Patent Application Publication
(10) Pub. No.: US 2021/0162623 A1
(43) Pub. Date: Jun. 3, 2021

(54) APPARATUS AND METHOD FOR HEAT TREATING WOOD

(71) Applicant: Dwight Frederick Bloye, Aurora (CA)

(72) Inventor: Dwight Frederick Bloye, Aurora (CA)

(21) Appl. No.: 17/109,726

(22) Filed: Dec. 2, 2020

Related U.S. Application Data
(60) Provisional application No. 62/942,845, filed on Dec. 3, 2019.

(51) Int. Cl. B27K 5/00

(52) U.S. Cl. CPC B27K 5/0085; B27K 5/001

(57) ABSTRACT

A method of heat treating a wood board comprises: passing a wood board from an input end to a discharge end of a conveyor; and heating the board with radiant heat as it is passes along the conveyor, the heating can be such as to provide significant charring of the wood. The wood board is then brushed with at least one rotating brush. An apparatus, for carrying out the method, has a conveyor for conveying a wood board having an input end and a discharge end. A radiant heater is located above the conveyor for heating the wood board, and a rotating brush is mounted for rotation above the conveyor, for brushing the wood board after heating.

### RELATED APPLICATION

This application claims the benefit of Provisional Application Ser. No. 62/942,845, filed Dec. 3, 2019, which is hereby incorporated herein by reference.

### FIELD OF THE INVENTION

This disclosure relates generally to an apparatus and method for heating treating wood.

### BACKGROUND

The following paragraphs are not an admission that anything discussed in them is prior art or part of the knowledge of persons skilled in the art.

A traditional Japanese process for treating wood comprises intensely burning and brushing the wood as a preservative heat treatment. It may be known as Shou Sugi Ban or Yakisugi. It is commonly applied to cypress. The heat treatment is alleged to improve siding longevity by preventing decay and insect infestation, to make wood planks more dimensionally stable, and to improve fire retardancy.

Such treatment many also create grain patterns in the wood, that are considered attractive. The process may only require heat treatment and brushing, so there are no potential allergens added, which may be desirable for some commercial and office applications.

Traditionally, the Shou Sugi Ban process was done over an open fire, banding three boards together into a triangular chimney, and standing it over the fire. The fire would burn up the inside of the boards, then be knocked apart. Then any fire on the boards would be extinguished and the boards brushed. More recent techniques have been developed, but these are largely unsuitable for production quantities,

### INTRODUCTION

The following paragraphs are intended to introduce the reader to the more detailed description that follows and not to define or limit the claimed subject matter. This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

### DESCRIPTION OF THE DRAWING FIGURES

For better understanding of the present invention and to show more clearly how it may be carried out in effect, reference will now be made, by way of example, to the drawings which show an example of an apparatus of the present disclosure and in which:

FIG. 1 is a perspective view of the discharge end of an apparatus of the present disclosure;

FIG. 2 is a perspective view of part of the apparatus of the present disclosure, showing boards being treated;

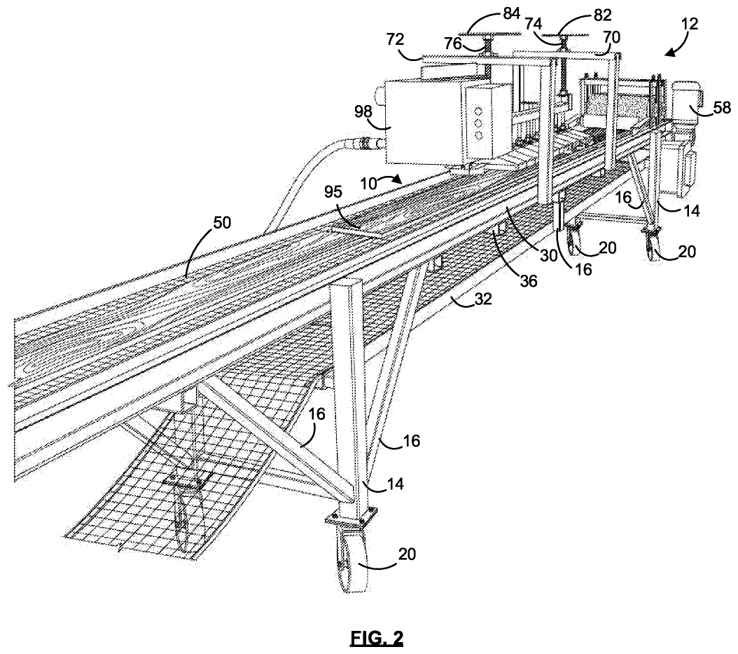

FIG. 3 is perspective enlarged view of part of the apparatus of the present disclosure, showing details of the radiant heaters and burners;

FIG. 4 is an enlarged view along the length of the apparatus of the present disclosure;

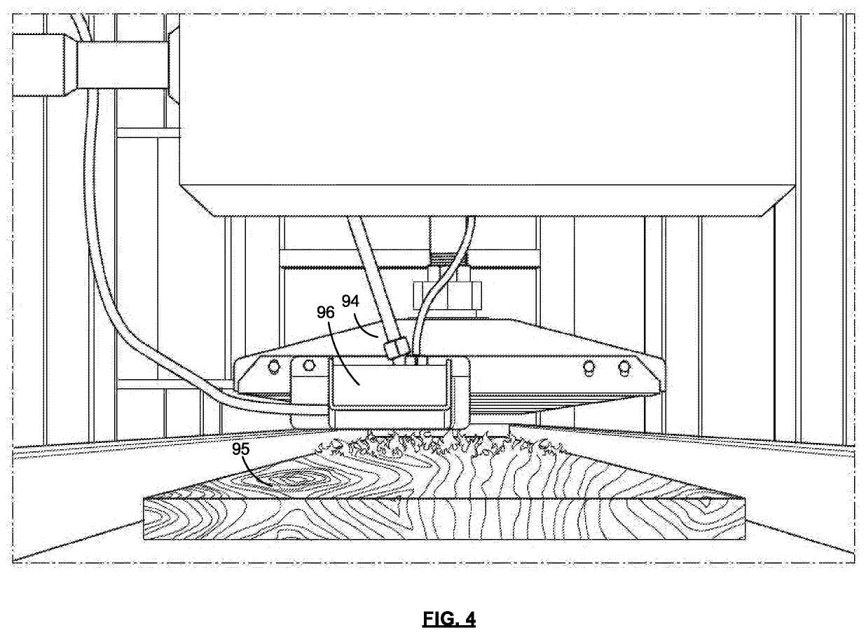

FIG. 5 is a side view of one end of the apparatus of the present disclosure;

FIG. 6 is perspective view of the radiant heaters and burners of the apparatus of the present disclosure;

FIG. 7 is an end view of the apparatus of the present disclosure;

FIG. 8 is a side view of the apparatus of the present disclosure, showing brushes; and

FIG. 9 is a side view of the other end of the apparatus.

### DESCRIPTION OF THE EMBODIMENTS

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein. Furthermore, this description is not to be considered as limiting the scope of the embodiments described herein in any way, but rather as merely describing the implementation of various embodiments as described.

The apparatus of the present disclosure has a main frame 10, which has longitudinal frame members 12. Supporting legs 14 support the longitudinal frame members 12, and diagonal bracing members 16 connect to the supporting legs 14 to the frame members 12. The longitudinal frame members 12 may be I section members, and both the supporting legs 14 and bracing members 16 may be square section channels, welded to the longitudinal frame members 12.

Cross or tie members 18 extending between and beneath the longitudinal frame members 12. The tie members 18 may also be square section channels, welded to the frame members 12. Optionally, to enable ready movement of the apparatus, wheels 20, which include, but are not limited to, caster wheels, are mounted on the supporting legs 14.

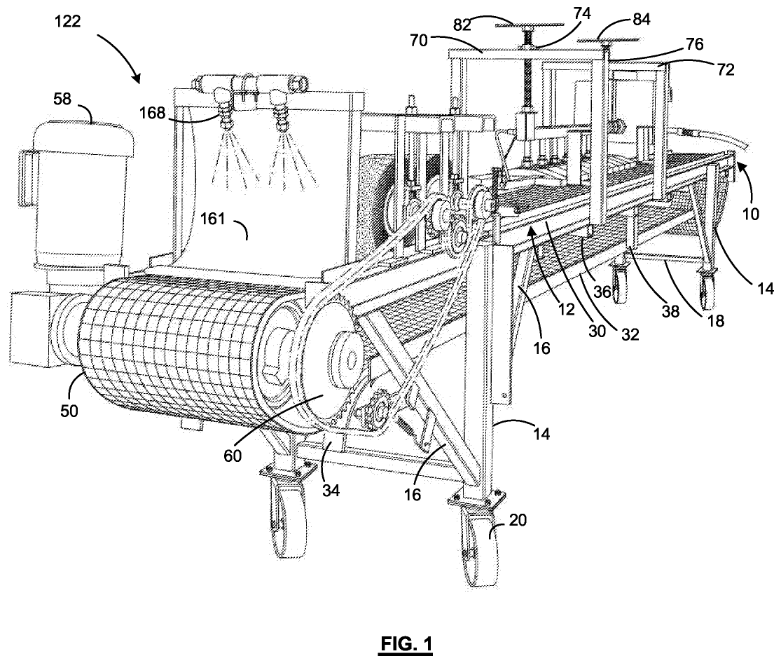

Upper L section channel members 30 are mounted on the longitudinal frame members 12, with horizontal flanges 36 extending inwardly towards one another. Lower L channel members 32 are secured, e.g. by welding, to the supporting legs 14, below the longitudinal frame members 12. Additionally, vertical support members 38 may be provided to support these lower L channel members 32. As for the upper channel members 30, the lower channel members 32 have horizontal flanges 36 extending inwardly and towards one another. At a discharge end, as shown in FIG. 1, the lower channel members 32 include flange extensions that curve downwardly, which may be formed by cutting away the vertical leg of the L section channels.

A steel chain conveyor belt 50 is provided for supporting and transporting wood boards 95. The conveyor belt 50 may be formed from any suitable material and in any suitable manner that is capable of supporting the wood boards or planks 95. The conveyor belt provides a generally planar surface that supports and conveys the wood boards or planks 95. It may not require any elements to engage the wood boards or planks 95. Where a particularly vigorous brushing action is provided, the belt 50 may include projecting elements to engage wood boards or planks 95 to prevent them slipping on the conveyor 50. It will be understood that, in use, the conveyor generally not be completely covered by wood boards or planks 95, so that parts of the conveyor will be subject to the full radiant heat from a burner assembly 90 detailed below. Thus, the conveyor 50 will be formed from steel or other material capable of withstanding the heat from the burner assembly 90.

Along the length of the apparatus, the L channel members 30 serve to support the steel chain conveyor belt 50 in a first direction, and the L channel members 32 serve to support the steel chain conveyor belt 50 in a second, return direction. At a discharge end of the apparatus, there is a drive shaft 52 on, mounted in a pair of bearings, which in turn are mounted on the ends of the longitudinal frame members 12. On the drive shaft 52, between the bearings 54, there are 3 toothed sprocket wheels 56 (not shown in detail), with two sprocket wheels mounted to engage outer edges of the conveyor belt 50, and a third sprocket mounted to engage the centre line of the conveyor belt 50. The drive shaft 52 and sprocket wheels may be in the form of a cylinder with teeth providing the sprocket drive.

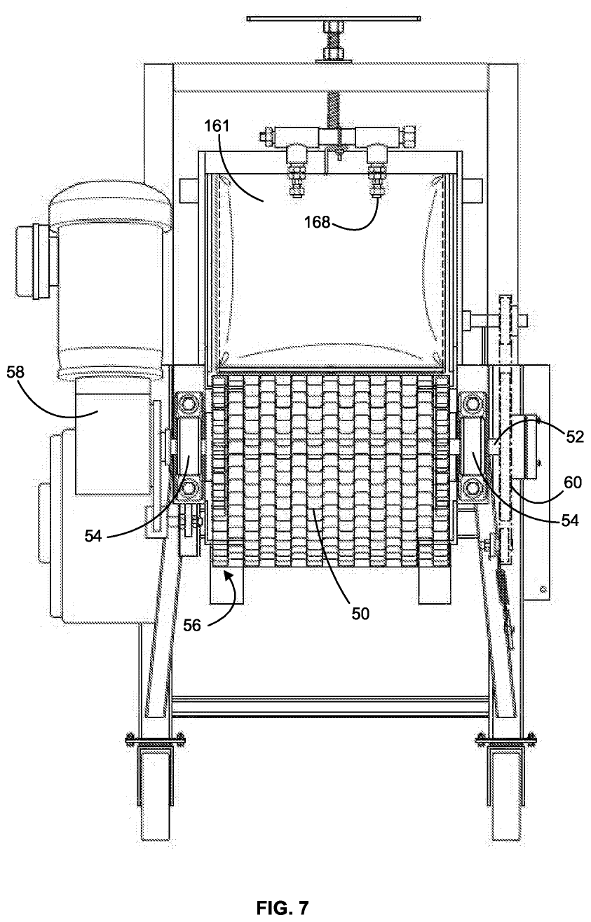

As shown in FIG. 7, the drive shaft 52 extends outside the bearings 54. On one side, an electric drive motor 58 is connected through a transmission 60 to the drive shaft 52. In known manner, the transmission 60 can provide required reduction gearing, which may be a worm drive.

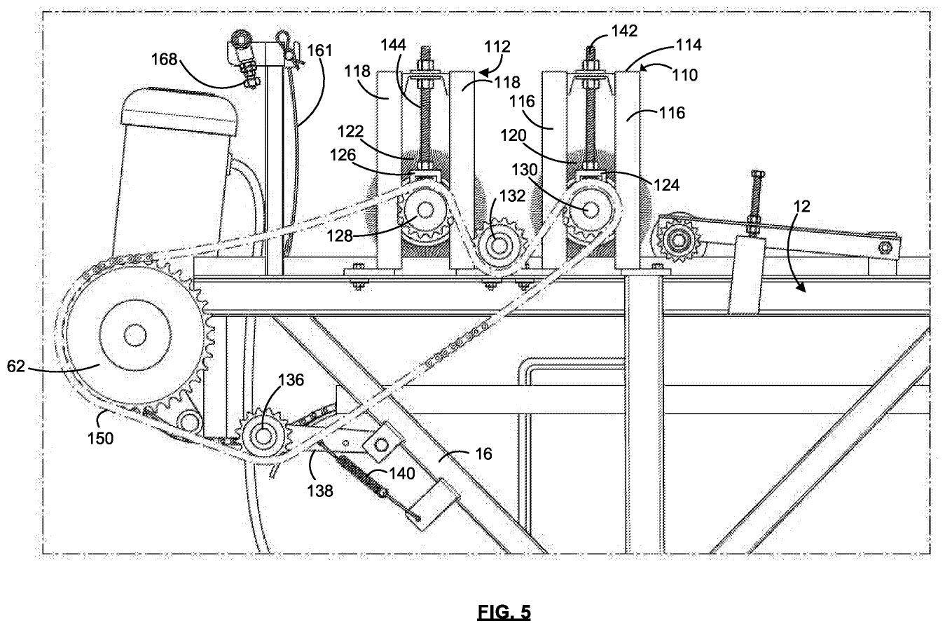

On the other end of the drive shaft 52, on the discharge end of the apparatus, there is mounted a drive sprocket 62, for driving brushes, as shown in FIG. 5.

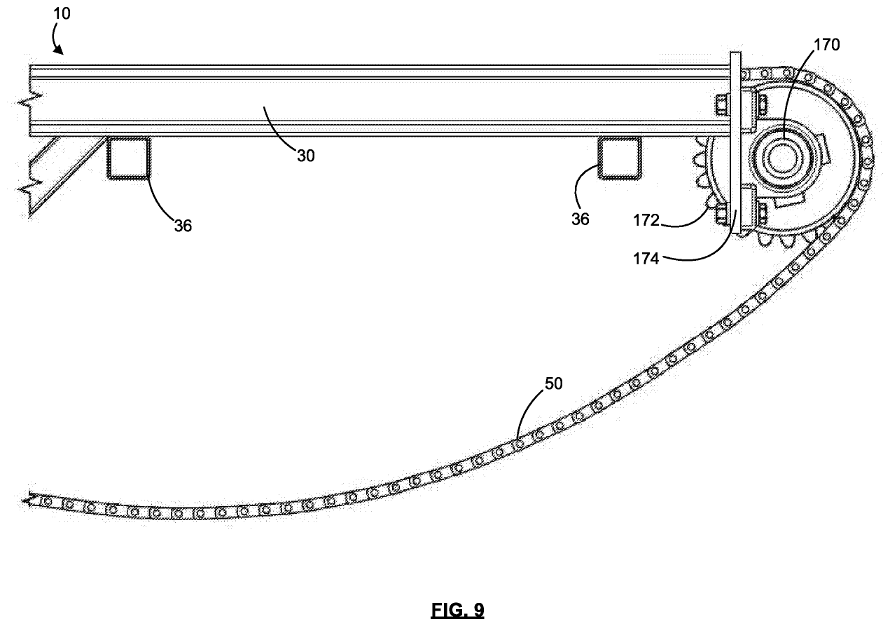

As shown in FIG. 9, at the other end of the main frame 10, there is an end, idler shaft or cylinder 170 provided with sprockets or teeth 172 and mounted in bearings 174.

Above the longitudinal frame members 12, there are a number of additional frame elements. Two inverted U frames 70 and 72 have side legs, which may be square section channels, welded or otherwise secured to the longitudinal frame members 12. The U frames 70 and 72 have top members, which may be inverted U section channels, connected to the side legs and providing respective threaded mounts 74 and 76 for respective screw mounting shafts 78 and 80.

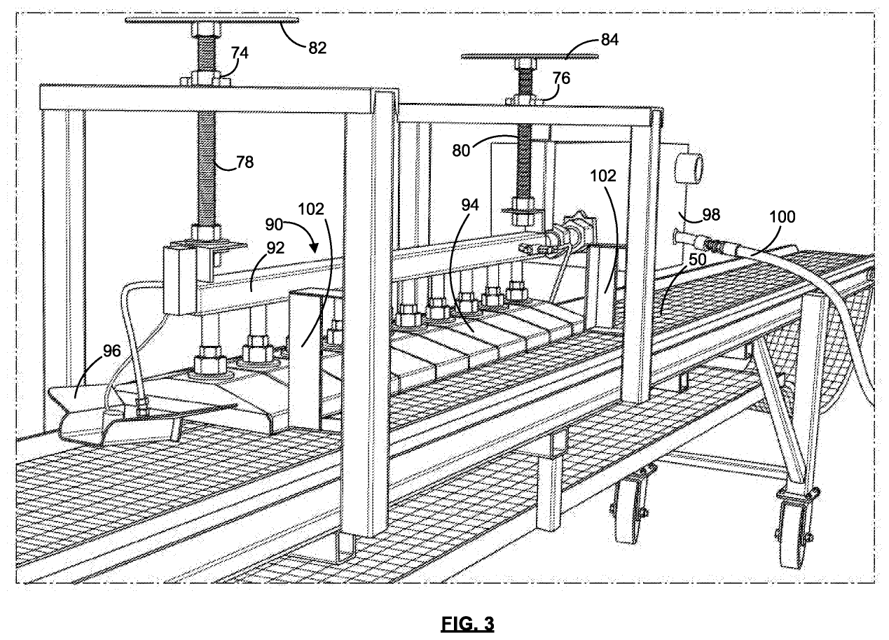

As best shown in FIG. 3, an infrared radiant heater or burner assembly generally indicated at 90, includes a longitudinal tube 92, connected to individual infrared radiant heaters or burners 94 by a short connecting tubes. At one end, and igniter 96 is provided. At the other end, a control unit 98 is provided connected to a gas supply line 100, for supplying combustible gas to the infrared radiant heaters or burners 94. While gas fired infrared radiant heaters are shown, it will be understood that any suitable heater could be used, for example electric radiant heaters.

The screw shafts 78, 80, at their lower ends are mounted for rotation in flanges secured to the longitudinal tube 92. For example and as shown, knots can be secured to the shafts 78, 80 both above and below each of the flanges, so that the screw shafts simply rotate within apertures in the flanges. As shown, handles, 82, 84 are provided at the upper end of the screw shafts 78, 80, for rotating the shafts stop rotation of the shaft 78, 80, in their screw mounts 74, 76 can be used to raise and lower the infrared radiant heater or burner assembly 90 as required.

To provide additional guidance or alignment to the radiant heater or burner assembly 90, brackets 102 can be provided.

To further inverted frames 110, 112, which are generally similar, are also mounted to the longitudinal frame members 12. Each inverted frame 110, 112 comprises an inverted U-shape channel 114, and a pair of legs 116 on one side and a pair of legs 118 on the other side. As shown in FIG. 5, the inverted U-shaped channels 114 one inverted frame 110 may extend out beyond the side of the frame 12, on one side.

First and second cylindrical brushes 120, 122 are mounted on the shaft, with the shafts mounted in pairs of respective bearings 124,126. On one side, for each of the cylindrical brushes 120, 122, a mounting shaft 142, 144, extends through the respective bearing 124, 126, for mounting of a respective drive sprocket 128, 130. An idler sprocket 132 is mounted to a support bracket 134. A further idler and tension sprocket 136 is rotatably mounted on the end of an arm 138 that is pivotally mounted to a flange attached to one of the bracing members 16. The tension spring 140 is connected between the arm 138 and the bracing member 16.

A drive chain 150 engages all of the sprockets 62, 128, 130, 132 and 136. The tension and idler sprocket 136 ensures that the chain is maintained in tension. The idler sprocket 132 ensures that the chain 150 fully engages both of the drive sprockets 128, 130. As detailed below, the bearings 124 and 126 are mounted for vertical sliding movement in the side legs 116, 118, to permit vertical adjustment of the position of the cylindrical brushes 120, 122. The provision of the idler and tension sprocket 136, and its range of motion ensures that a suitable tension can be maintained in the chain 150, irrespective of the vertical position of the brushes 120, 122.

As explained below, to accommodate different thicknesses of boards, and to enable the intensity of the brushing to be varied, the vertical position of the brushes 120, 122 is adjustable. To this end, the bearings 124, 126 are slidably mounted in the side legs 116, 118. In a similar manner to the adjustment for the radiant heater or burner assembly 90, pairs of respective threaded shafts are provided for the brushes 120, 122. Each threaded shaft 142, 144, at its lower end, may have a pair of nuts secure thereto, and on either side of the flanges of the bearings 124, 126, so as to provide a simple, rotating support for the respective brush 120, 122. At its upper end, each mounting shaft 142, 144 may be provided with further nuts, as shown, on either side of the inverted U-shaped channel 114. By adjusting the position of these nuts along the shafts 142, 144, the vertical position of the shafts 142, 144, and hence the vertical location of the brushes 120, 122 can be adjusted.

A further and final inverted frame 160 is attached to the longitudinal frame members 12. A damping cloth 161 is mounted to this frame 160. For this purpose, the cloth 161 could be formed to provide an elongate channel into which a rod 162 is inserted. In known manner, the rod 162 can be supported, at either end, in brackets 164 and secured with clips 166.

The frame 160 is also provided with spray nozzles 168 that would be connected to a water source.

In use, the electric drive motor 58 is used to drive the sprockets 56, to pull the chain conveyor belt along a top run in the upper channel members 30, from the end shaft 65 towards the damping cloth 162. The chain conveyor belt, returns, in a lower run supported by the lower channel members 32, below the top run. As shown, the length of the chain is such as to leave a substantial loop of the chain conveyor belt hanging between the ends of the lower channel members 32 and the end shaft 65. This loop is dimensioned to have sufficient weight, to provide sufficient attention to pull the chain conveyor belt 50 along the channel members 32 and to maintain that lower run of the conveyor belt generally in tension, as shown.

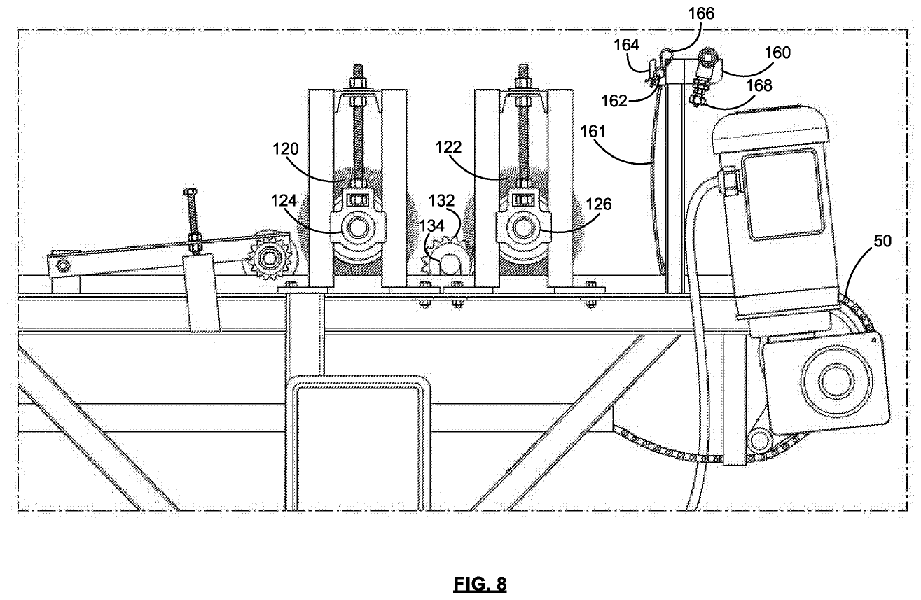

Simultaneously, as the motor drives the conveyor belt 50, the drive sprocket 62, on the end of the drive shaft 52, drives the chain 150. Consequently, the chain 150 drives the cylindrical brushes 120, 122 causing the brushes to rotate clockwise, as viewed in FIG. 8, effectively causing the bottom surfaces of the brushes 120, 122 to be moving in the opposite direction to the motion of the chain conveyor belt 50.

It will therefore be understood that this basic configuration provides for the chain conveyor belt to transport wood boards or planks 95 from one end, under the infrared radiant heater or burner assembly 90, under the brushes 120, 122 and under the damping cloth 162, to be discharged from the apparatus.

To achieve a desired charring and heat treatment of the wood boards or planks 95, a number of parameters can be varied. Firstly, the speed of the chain conveyor belt 50 can be varied as desired. In this configuration, this will inherently vary the rotational speed of the rotating brushes 120, 122. It will be understood that, in alternate configurations, a separate drive can be provided to the brushes 120, 122, so that their speed can be independent of the speed of the chain conveyor belt 50.

A number of parameters of the infrared radiant heater or burner assembly 90 can be varied. Firstly, using the mounting shafts 78, 80, the height of the radiant heater or burner assembly 90 can be adjusted as desired. The height can be adjusted, for example, in accordance with the thickness of the wood boards or planks 95 being treated and/or in accordance with the desired height or spacing between the radiant heaters or burners 94 and the wood boards or planks 95, which in turn may depend upon the type of wood 95 being treated.

The level of radiant heat provided by the radiant heater or burner assembly 90 can also be adjusted. Thus, the number of radiant heaters or burners 94 that are actually activated for anyone treatment session can be adjusted, and it is not necessary for all of the banners to be lit. In addition, the heat provided by each radiant heater or burner 94 can be adjusted, by adjusting the amount of gas supplied to it.

The height of the brushes 120, 122 can be adjusted. As for the radiant heater or burner assembly 90, the thickness of the wood boards or planks 95 being treated may be a parameter used to determine the height of the brushes. Additionally, the height of the brushes 120, and 22 may be varied depending upon, for example, the level of brushing required, the hardness or other qualities of the wood 95 being treated.

Examples of variations in parameters for different elements of the apparatus for different types of wood are given in the following table:

| | | Burner | | |
|---|---|---|---|---|
| Wood | Burner | assembly | Conveyor | Brush |
| Type | Temperature | Height | Speed | Height |
| Cedar | 750° F.-1800° F. | 2½″-5″ | 35 fpm-60 fpm | ½″-1½″ |
| | (400° C.-980° C.) | | | |
| Pine | 1000° F.-1800° F. | 2″-6″ | 32 fpm-45 fpm | ¾″-3½″ |
| | (540° C.-980° C.) | | | |
| Fir | 1200° F.-1800° F. | 2½″-5½″ | 32 fpm-40 fpm | ¾″-3″ |
| | (650° C.-980° C.) | | | |
| Tamarak/ | 1000° F.-1800° F. | 2″-6″ | 32 fpm-45 fpm | ¾-2½″ |
| Larch | (540° C.-980° C.) | | | |

As indicated in the above table, the various parameters can be adjusted for different types of wood 95. The conveyor speed is expressed in feet per minute (fpm). The heights for the burner assembly 90 and the brushes 120, 122 are expressed in inches above the level of the conveyor 50. For the burner assembly 90, this measurement is the distance between the bottom of the individual burners 94 and the top of the conveyor 50. For the brushes, the measurement again is in inches and is measured between the lowermost point of the brushes 120, 122 when not in contact with the wood and the conveyor 50. It will be understood that, to achieve the necessary brushing action, the lowermost point of the brushes needs to be below the top of the wood board.

For this purpose allowance has to be made for the fact that the actual thickness of wood boards or planks 95 (at least in N. America) is less than a nominal dimension or thickness of the lumber, before it's dressed/planed. For example, for a ¾″ thick cedar board, the actual thickness may only be about ⅝″ thick. Accordingly, the brushes 122, 124 may be set at ½″ above the conveyor 50, which will put the extended bristles of the brush at ⅛″ below the surface of the board. The bristles will bend when they come in contact with the board, which will provide the necessary pressure and brushing action.

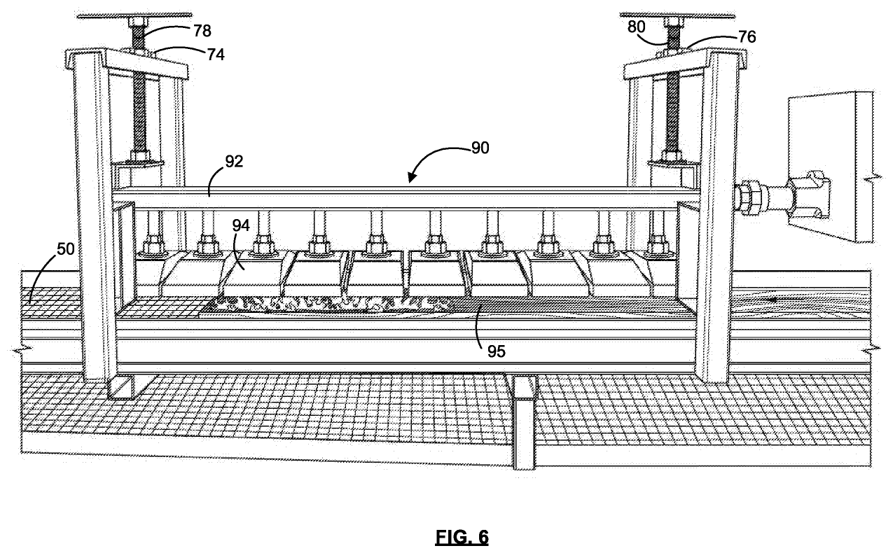

The heat treatment of the wood boards or planks 95 is intended to affect significant charring of the wood 95, to provide an attractive appearance and/or to enhance the appearance of the wood 95. In many cases, the level of heat will be such that the wood 95 catches fire, to some extent, as shown in FIG. 6. For this reason, the damping cloth 162 is provided at the end of the conveyor belt 50. As the word passes under the brushes 120, 122, it then passes under the damping cloth 162, which is sprayed with water, to extinguish any flames or burning on the wood boards or planks 95. Additionally, the brushes 120, 122 would be formed from bristles that are resistant to heat or flames, e.g. the brushes may be formed with steel bristles.

While the apparatus and method have been described as including rotating brushes. The present disclosure envisages that any suitable motion can be applied to the brushes that will effect the required brushing action. For example, the brushes can have a planar brushing surface and be provided with oscillating movements along a line, which be aligned with the direction of motion of the wood board or at an angle to the wood board. It is also possible that a brush or brushes can be mounted for rotation about an axis perpendicular to the surface of the wood board, the rotation being either continuous or oscillating.

A number of embodiments have been described herein. However, it will be understood by persons skilled in the art that other variants and modifications may be made without departing from the scope of the embodiments as defined in the claims appended hereto. A person skilled in the art will also recognize that the embodiments described above should be read as representative of a plethora of permutations and combinations not explicitly described, the permutations and combinations incorporating elements from various embodiments. More particularly, other variants may comprise any possible, practical combinations of features disclosed in the claims, beyond those defined by the claims and their dependencies.

1. An apparatus, for heat treating wood, the apparatus comprising: a conveyor for conveying a wood board having an input end and a discharge end; a radiant heater located above the conveyor for heating the wood board; and a rotating brush mounted for rotation above the conveyor, for brushing the wood board after heating by the radiant heater.

2. An apparatus as claimed in claim 1, wherein the radiant heater is a gas heater powered by combustible gas, wherein optionally the radiant heater comprises a radiant heater assembly comprising a plurality of individual radiant burners and a control unit, enabling individual control of the individual radiant burners, and wherein optionally the radiant heater assembly extends longitudinally along and transversely across the conveyor, and the individual radiant burners are configured to permit the effective longitudinal extent and transverse extent of the radiant burner assembly to be varied by operation of selected individual radiant burners.

3. An apparatus as claimed in claim 2, wherein the height of the radiant heater assembly above the conveyor is adjustable, and wherein optionally the conveyor is mounted on a main frame, at least two inverted U-shaped frames are mounted on the mainframe above the conveyor, threaded shafts are mounted in the new-shaped frames and the radiant heater assembly is suspended from threaded shafts, rotation of the threaded shafts enabling adjustment of the height of the radiant heater assembly.

4. An apparatus as claimed in claim 1, wherein the rotating brush is mounted for rotation about a generally horizontal axis, and is arranged in use to have a lower portion of the brush, engaging the wood board, moving in a direction opposite to a direction of motion of the conveyor.

5. An apparatus as claimed in claim 4, including one of two rotating brushes, rotating in the same direction about generally horizontal axes, and two rotating brushes, rotating in opposite directions relative to one another.

6. An apparatus as claimed in claim 5, wherein the two brushes are driven by one of a common chain drive and a common belt drive, wherein optionally the height of the brushes above the conveyor is adjustable, and wherein optionally each brush has a mounting shaft, mounted in a pair of bearings, on either side of the brush; for each brush, support legs extent up from the frame, and the bearings for that brush our slidably mounted on the support legs, to permit the height of the brush to be adjusted.

7. An apparatus as claimed in claim 6, wherein the brushes are driven by a chain drive, and the apparatus includes at least one of an idler sprocket and a tension sprocket for maintaining the chain drive tension, wherein optionally a drive shaft is provided at one end of the conveyor for driving the conveyor, and a drive sprocket is mounted to the drive shaft and engaged to the chain drive to drive the chain drive, and wherein optionally the main frame provides support for upper and lower runs of the conveyor, the upper run being above the lower run for conveying the wood board.

8. Apparatus as claimed in claim 75, wherein the drive shaft is provided at a discharge end of the conveyor, and an idler shaft supports the conveyor at an opposite, input end of the conveyor, and the support for the lower run of the conveyor provides for a freely hanging loop of the conveyor adjacent the idler shaft, the weight of the loop of the conveyor serving to maintain the lower run of the conveyor in tension.

9. An apparatus as claimed in claim 1, wherein a drive shaft is provided at one end of the conveyor for driving the conveyor, and a main drive sprocket is mounted to the drive shaft, the brush includes a brush drive sprocket and a chain drive is provided engaging the main and brush drive sprockets, for rotating the brush, wherein optionally the main frame provides support for upper and lower runs of the conveyor, the upper run being above the lower run for conveying the wood board, and wherein optionally the drive shaft is provided at a discharge end of the conveyor, and an idler shaft supports the conveyor at an opposite, input end of the conveyor, and the support for the lower run of the conveyor provides for a freely hanging loop of the conveyor adjacent the idler shaft, the weight of the loop of the conveyor serving to maintain the lower run of the conveyor in tension.

10. An apparatus as claimed in claim 1, including a cloth provided hanging adjacent the discharge end of the conveyor and a water supply for wetting the cloth, the whereby the wood board passes under the wetted cloth and the wetted cloth serves to extinguish any flames on the wood board.

11. An apparatus, for heat treating wood, the apparatus comprising: a conveyor for conveying a wood board having an input end and a discharge end; and a radiant heater located above the conveyor for heating the wood board, wherein the conveyor supports and and conveys wood boards and is formed from a material that withstands the heat from the radiant heater.

12. An apparatus as claimed in claim 11, wherein the radiant heater is a gas heater powered by combustible gas, wherein optionally the radiant heater comprises a radiant heater assembly comprising a plurality of individual radiant burners and a control unit, enabling individual control of the individual radiant burners, and wherein optionally the radiant heater assembly extends longitudinally along and transversely across the conveyor, and the individual radiant burners are configured to permit the effective longitudinal extent and transverse extent of the radiant burner assembly to be varied by operation of selected individual radiant burners.

13. An apparatus as claimed in claim 12, wherein the height of the radiant heater assembly above the conveyor is adjustable.

14. An apparatus as claimed in claim 13, wherein a drive shaft is provided at one end of the conveyor for driving the conveyor, and a drive sprocket is mounted to the drive shaft and engaged to the chain drive to drive the chain drive.

15. An apparatus as claimed in claim 14, wherein the main frame provides support for upper and lower runs of the conveyor, the upper run being above the lower run for conveying the wood board.

16. Apparatus as claimed in claim 15, wherein the drive shaft is provided at a discharge end of the conveyor, and an idler shaft supports the conveyor at an opposite, input end of the conveyor, and the support for the lower run of the conveyor provides for a freely hanging loop of the conveyor adjacent the idler shaft, the weight of the loop of the conveyor serving to maintain the lower run of the conveyor in tension.

17. A method of heat treating a wood board, the method comprising:
passing a wood board from an input end to a discharge end of a conveyor;
heating the board with radiant heat as it is passes along the conveyor; and
after heating the wood board, brushing the wood board with at least one rotating brush.

18. A method as claimed in claim 17 including adjusting at least one of: the speed of the conveyor; the intensity of the radiant heat; and the height of the brushes above the board.

19. A method as claimed in claim 18, including providing the heat from the radiant burner assembly comprising a plurality of individual radiant burners, and adjusting at least one of the number of burners that are operating and the intensity of heat provided by each individual burner.

20. A method as claimed in claim 17, including providing at least two brushes and rotating the brushes so that lower portions of the brushes, engaging the wood board, move in a direction opposite to a direction of motion of the conveyor, optionally including providing radiant heat from radiant heaters and varying the temperature of the radiant heaters in the range of 400° C.-980° C., and optionally 540° C.-980° for pine and tamarak/larch and C650° C.-980° C. for fir, optionally including varying the height of the radiant heaters in the following ranges for different woods: 2½″-5″ for cedar; 2″-6″ for pine; 2½″-5½″ for fir; and 2″-6″ for tamarak/larch, and optionally including varying the speed of the conveyor in the following ranges for different woods: 35-60 fpm (feet per minute) for cedar; 32-45 fpm for pine; 32-40 fpm for fir; and 32-45 fpm for tamarak/larch.
